(19) United States
(12) Patent Application Publication
(10) Pub. No.: US 2025/0170944 A1
(43) Pub. Date: May 29, 2025

(54) RAMP MODULE OF VEHICLE

(71) Applicants: Hyundai Motor Company, Seoul (KR); Kia Corporation, Seoul (KR)

(72) Inventors: Jiae Yong, Hwaseong-si (KR); Jejoon Lee, Hwaseong-si (KR); Dong Ho Kang, Hwaseong-si (KR); Dong Kyu Kim, Hwaseong-si (KR)

(21) Appl. No.: 18/813,940

(22) Filed: Aug. 23, 2024

(30) Foreign Application Priority Data
Nov. 24, 2023 (KR) 10-2023-0165068

(51) Int. Cl. B60P 1/43; B60N 2/005; B62D 25/20; B62D 27/02; B62D 27/06

(52) U.S. Cl. CPC B60P 1/431; B62D 25/20; B62D 27/023; B62D 27/065; B60N 2/005

(57) ABSTRACT

An embodiment ramp module of a vehicle includes a lower radial vehicle body member including a plurality of center portion members arranged in a center portion of a lower portion of a vehicle body of the vehicle in transverse and longitudinal directions of the vehicle body, respectively, and a plurality of rear portion members arranged in the longitudinal direction of the vehicle body in a rear portion of the lower portion of the vehicle body, a center portion ramp module mounting member connecting the center portion members arranged in the transverse direction, a rear portion ramp module mounting member connecting the rear portion members and a bottom surface of the vehicle body, a center in-floor ramp module covering the center portion member and configured to slide along the center portion members arranged in the transverse direction, and a flattening rear member covering the rear portion members.

### CROSS-REFERENCE TO RELATED APPLICATIONS

This application claims the benefit of Korean Patent Application No. 10-2023-0165068, filed on Nov. 24, 2023, which application is hereby incorporated herein by reference.

### TECHNICAL FIELD

The disclosure relates to a ramp module of a vehicle.

### BACKGROUND

In general, vehicles for the transportation vulnerable to get in are equipped with an auxiliary boarding foothold (a ramp system). The ramp system is mainly used as an under-floor insertion type that is inserted into an underfloor of a vehicle and protrudes out of the vehicle when necessary or as a separate type using a separate device received in a trunk space of a vehicle.

In the case of a vehicle in which a user uses a wheelchair, as shown in FIG. 1, the entire body of the trunk side of a vehicle 1 is cut to secure space for wheelchairs, etc. to enter, and a separate ramp stored in the trunk space is used. The ramp device 4 is connected to a floor 3 inside the vehicle through the cut trunk side body, and a wheelchair may enter or exit the vehicle by opening the trunk side door 2.

In the case of the separate type, it may be difficult to secure space for receiving the ramp device when the ramp device is not in use, and the user should install the ramp device personally each time the ramp device is used due to a heavy weight thereof, making storage and use difficult. In addition, most of these vehicle models are manufactured by special equipment companies and are manufactured at high prices, so a customer base is limited.

### SUMMARY

The disclosure relates to a ramp module of a vehicle. Particular embodiments relate to an in-floor ramp module of a vehicle that includes a flattening panel mounted on a lower radial body member and slides.

Embodiments of the disclosure provide an in-floor ramp module which may be conveniently used by a user by accomplishing common use as widely as possible by using a lower radial body member of an existing vehicle without changing vehicle models, reinforcing rigidity of a vehicle body by installing a ramp module mounting member on a body member, installing a panel for flattening, and adopting a ramp device sliding through a side door of a vehicle.

According to an exemplary embodiment, a ramp module of a vehicle, installed in a vehicle body inside the vehicle, includes a lower radial vehicle body member including a plurality of center portion members arranged in a center portion of a lower portion of the vehicle body in transverse and longitudinal directions of the vehicle body and a plurality of rear portion members arranged in the longitudinal direction of the vehicle body in a rear portion of the lower portion of the vehicle body, a center portion ramp module mounting member installed to connect the center portion members arranged in the transverse direction, a rear portion ramp module mounting member installed to connect the rear portion member and a bottom surface of the vehicle body, a center in-floor ramp module installed to cover the center portion member and sliding along the center portion member disposed in the transverse direction, and a flattening rear member installed to cover the rear portion member.

The center portion ramp module mounting member may be connected to a side surface of the center portion member by welding.

The rear portion ramp module mounting member may be connected to a side surface of the rear portion member by welding.

The center in-floor ramp module may include a plurality of ramp module members fixed to the center portion member and a ramp installed to be slidable in the transverse direction of the vehicle body between the ramp module members.

The plurality of ramp module members may include a front ramp module member and a rear ramp module member disposed in the transverse direction of the vehicle body and a center ramp module member connecting central portions of the front and rear ramp module members and disposed in the longitudinal direction of the vehicle body.

The front and rear ramp module members may be formed in the shape of a hollow bar.

Lower surfaces of the front and rear ramp module members may be fixed to the vehicle body by a bolt, and a tool entry hole may be formed on an upper surface for bolt connection.

The flattening rear member may be disposed in the transverse direction of the vehicle body and formed in the form of a hollow bar.

A lower surface of the flattening rear member may be fixed to the vehicle body by a bolt, and a tool entry hole may be formed on an upper surface for bolt connection.

The ramp module may further include a center flattening panel covering the rear ramp module member, the center ramp module member, and the ramp, a front flattening panel covering the front ramp module member, and a rear flattening panel covering the flattening rear member.

The center flattening panel, the front flattening panel, and the rear flattening panel may be formed of an aluminum sheet.

The front flattening panel may be fixed to a rear surface of a first-row seat member of the vehicle body and the front ramp module member by a bolt.

The rear flattening panel may be fixed to a front surface of a third-row seat member of the vehicle body, a wheel side, and the flattening rear member by a bolt.

A rear portion reinforcing member may be further installed between the rear portion ramp module mounting members.

According to an embodiment of the disclosure, by adopting a structure in which an in-floor ramp module for the transportation vulnerable to get in is mounted on the lower radial body member, it is possible to respond to the purpose built vehicle (PBV) market of various specifications by maximizing common use without changing existing vehicle models.

In addition, by adding a ramp module mounting member to the lower radial body member, the rigidity of the vehicle body may be reinforced, thereby improving durability and crash performance.

In addition, by installing a flattening panel and employing a ramp device that is received below the panel and slides through a side door of the vehicle, an attractive appearance may be obtained and loading and usability may be improved.

### BRIEF DESCRIPTION OF THE DRAWINGS

FIG. 1 is a diagram showing a use state of an existing in-floor ramp module.

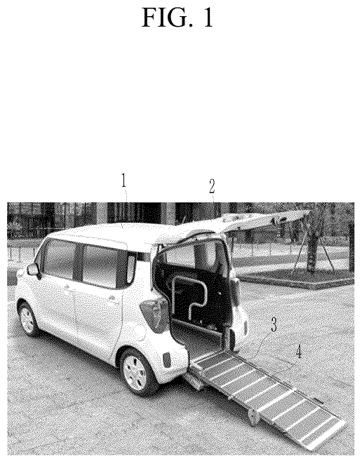

FIG. 2 is a diagram showing a lower radial body member of a vehicle installed on a vehicle body according to an embodiment of the disclosure.

FIG. 3 is a diagram showing a state in which a ramp module mounting member is installed on a lower radial body member of a ramp module of a vehicle according to an embodiment of the disclosure.

FIG. 4 is an enlarged view of portion ‘A’ in FIG. 3.

FIG. 5 is a diagram showing a state in which a ramp module mounting member is installed on a lower radial body member of a vehicle according to an embodiment of the disclosure when a ramp module is small in size and a load is small.

FIG. 6 is a diagram showing a state in which a ramp module mounting member is installed on a lower radial body member of a vehicle according to an embodiment of the disclosure when a ramp module is large in size and a load is large.

FIG. 7 is a diagram showing a center in-floor ramp module installed on a lower radial body member of a vehicle according to an embodiment of the disclosure.

FIG. 8 is a diagram showing a center in-floor ramp module and a flattening rear member installed on a lower radial body member of a vehicle according to an embodiment of the disclosure.

FIG. 9 is a cross-sectional view taken along line ‘B-B’ of FIG. 8.

FIG. 10 is a cross-sectional view taken along line ‘C-C’ of FIG. 8.

FIG. 11 is a view showing a center flattening panel installed on a ramp module member of a vehicle according to an embodiment of the disclosure.

FIG. 12 is a diagram showing a center flattening panel and a front flattening panel installed on a ramp module member of a vehicle according to an embodiment of the disclosure.

FIG. 13 is an enlarged view showing a fixed state of a front flattening panel of FIG. 12.

FIG. 14 is a diagram showing a center flattening panel, a front flattening panel, and a rear flattening panel installed on a ramp module member of a vehicle according to an embodiment of the disclosure.

FIG. 15 is an enlarged view showing a fixed state of a rear flattening panel of FIG. 14.

FIG. 16 is a diagram showing a rear portion reinforcing member further installed on a lower radial body member of a vehicle according to an embodiment of the disclosure.

### DETAILED DESCRIPTION OF ILLUSTRATIVE EMBODIMENTS

Hereinafter, reference now will be made to embodiments of the disclosure with reference to the attached drawings in a manner sufficiently detailed to be readily carried out by a person skilled in the art to which the disclosure pertains. As those skilled in the art would realize, the described exemplary embodiments may be modified in various different ways, all without departing from the spirit or scope of the disclosure.

In various embodiments, components having the same configuration are representatively described in an embodiment using the same reference numerals, and in other embodiments, only components that are different from those of the embodiment are described.

It should be noted that the drawings are schematically illustrated but not scaled in proportion. Therefore, in the attached drawings, the relative dimensions and proportions of the components are illustrated to be more enlarged or reduced than they actually are for clarification and convenience, and a certain size is just illustrative but not limited thereto. In the drawings, the same structures, elements, or parts have the same reference numerals so as to denote similar features even though they are illustrated in different figures. When it is said that any part is positioned “on” another part, it means the part is directly on the other part or above the other part with at least one intermediate part.

Exemplary embodiments specifically show preferred exemplary embodiments. As a result, various modifications of the drawings are anticipated. Therefore, the exemplary embodiments are not limited to a specific form of an illustrated region, and for example, include modifications of a manufactured form.

Hereinafter, a ramp module structure of a vehicle according to an embodiment of the disclosure is described in detail with reference to the accompanying drawings.

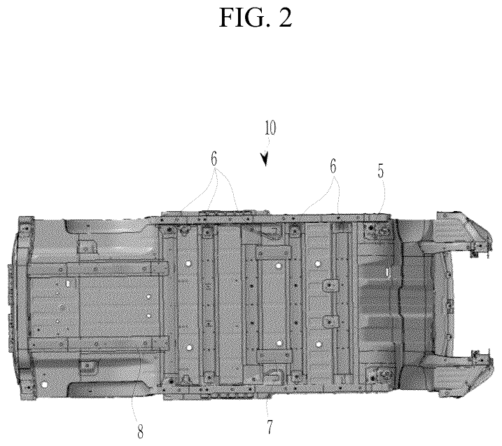

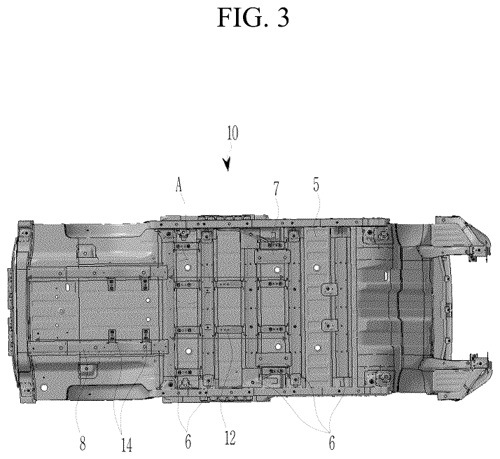

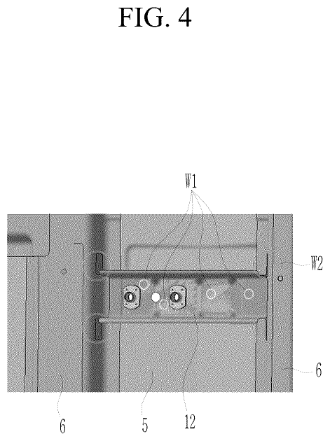

FIG. 2 is a diagram showing a lower radial body member of a ramp module 10 of a vehicle according to an embodiment of the disclosure installed on the vehicle body, FIG. 3 is a diagram showing a state in which a ramp module mounting member is installed on a lower radial body member of a ramp module of a vehicle according to an embodiment of the disclosure, and FIG. 4 is an enlarged view of portion ‘A’ in FIG. 3.

First, referring to FIG. 2, a ramp module 10 of a vehicle according to an embodiment of the disclosure includes lower radial body members 6, 7, and 8. The lower radial body members 6, 7, and 8 include a plurality of center portion members 6 and 7 disposed in a center portion of a lower portion of the vehicle body 5 and a plurality of rear portion members 8 disposed in a rear portion of the lower portion of the vehicle body 5.

The plurality of center portion members 6 and 7 may be arranged in the transverse and longitudinal directions of the vehicle body 5, respectively. In FIG. 2, a case in which five center portion members 6 are arranged in the transverse direction and two center portion members 7 are arranged in the longitudinal direction is illustrated as an example, but the number is not limited thereto. The center portion members 7 arranged in the longitudinal direction may connect second and third center portion members 6 arranged in the transverse direction from the front of the vehicle body 5 and may be disposed in a side portion of the vehicle body 5, respectively.

A plurality of rear portion members 8 may be disposed in the rear portion of a lower portion of the vehicle body 5 in the longitudinal direction of the vehicle body 5. The rear portion member 8 may vertically connect the rearmost center portion member 6 among the center portion members 6 disposed in the transverse direction and the rearmost portion of the vehicle body 5.

The lower radial vehicle body members 6, 7, and 8 as described above may be attached to the vehicle body 5 by welding.

Referring to FIG. 3, the ramp module 10 of a vehicle according to an embodiment of the disclosure includes a center portion ramp module mounting member 12 and a rear portion ramp module mounting member 14. The center portion ramp module mounting member 12 may connect the center portion members 6 disposed in the transverse direction, and the rear portion ramp module mounting member 14 may be installed to connect the rear portion member 8 and the bottom surface of the vehicle body 5.

In FIG. 3, a case in which four center portion ramp module mounting members 12 are arranged between second and third center portion members 6 in the transverse direction, two center portion ramp module mounting members 12 are arranged between the third and fourth center portion members 6, and four center portion ramp module mounting members 12 are arranged between the fourth and fifth center portion members 6 is illustrated as an example, but the numbers are not limited thereto.

In addition, two rear portion ramp module mounting members 14 may be installed on each of the two rear portion members 8.

As shown in FIG. 4, the center portion ramp module mounting member 12 may be connected to the bottom surface of the vehicle body 5 and to the side surface of the center portion member 6 by welding, for example, at welding points W1 and W2, respectively. Similarly, although not shown, the rear portion ramp module mounting member 14 may be connected to the side surface of the rear portion member 8 and the bottom surface of the vehicle body 5 by welding.

Due to the installation of the ramp module mounting members 12 and 14 shown in FIGS. 3 and 4, impact transmitted from the front of the vehicle body 5 is transmitted to the rear portion member 8 and the rear portion ramp module mounting member 14 through the center portion members 6 and 7 and the center portion ramp module mounting member 12 and finally transmitted to the rear of the vehicle body 5, thereby completing a multi-load path. Therefore, by installing the center portion ramp module mounting members 12 and the rear portion ramp module mounting members 14, impact may be smoothly transmitted and distributed from the front to the rear of the vehicle body 5.

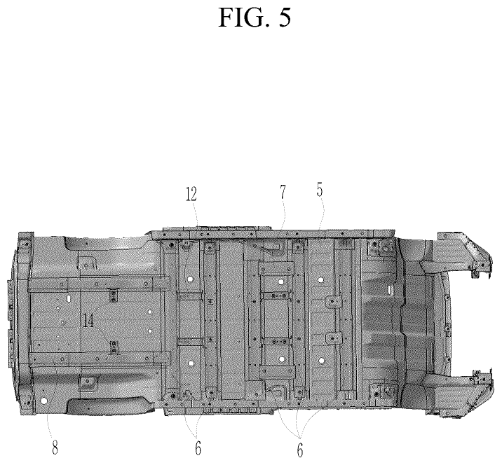

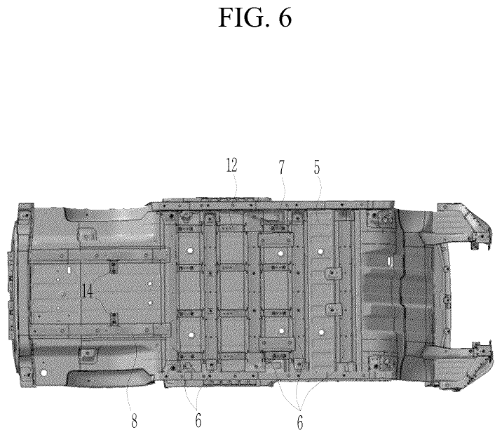

FIG. 5 is a diagram showing a state in which a ramp module mounting member is installed on a lower radial body member of a vehicle according to an embodiment of the disclosure when a ramp module is small in size and a load is small, and FIG. 6 is a diagram showing a state in which a ramp module mounting member is installed on a lower radial body member of a vehicle according to an embodiment of the disclosure when a ramp module is large in size and a load is large.

As shown in FIG. 5, when the size of the ramp module is small and the load is small, the number of center portion ramp module mounting members 12 and the number of rear portion ramp module mounting members 14 may be reduced.

In addition, as shown in FIG. 6, when the ramp module is large in size and a load is large, the number of center portion ramp module mounting members 12 may be increased. In addition, although not shown in FIG. 6, the number of rear portion ramp module mounting members 14 may be increased. That is, three or more rear portion ramp module mounting members 14 may be installed on each of the two rear portion members 8.

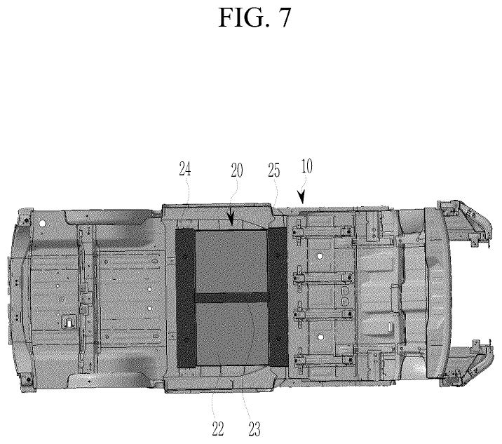

FIG. 7 is a diagram showing a center in-floor ramp module installed on a lower radial body member of a vehicle according to an embodiment of the disclosure.

Referring to FIG. 7, the ramp module 10 of a vehicle according to an embodiment of the disclosure may include a center in-floor ramp module 20 installed to cover the center portion members 6 and 7 and slidably moving along the center portion member 6 disposed in the transverse direction.

The center in-floor ramp module 20 includes a plurality of ramp module members 23, 24, and 25 fixed to the center portion members 6 and 7 and a ramp 22 installed to be slidable in the transverse direction of the vehicle body 5 between the ramp module members 23, 24, and 25.

The plurality of ramp module members 23, 24, and 25 fixed to the center portion members 6 and 7 may include a front ramp module member 25 disposed in the transverse direction of the vehicle body 5 at the front of the vehicle body 5, a rear ramp module member 24 disposed in the transverse direction of the vehicle body 5 at the rear of the vehicle body 5, and a center ramp module member 23 connecting the central portions of the front and rear ramp module members 25 and 24 and disposed in the longitudinal direction of the vehicle body 5.

The ramp 22 may be configured as two ramps 22 that slide in the transverse direction of the vehicle body 5 on both sides of the center ramp module member 23. That is, each ramp 22 may be slidably moved to be drawn out through left and right doors of the vehicle and used when a passenger gets on and off.

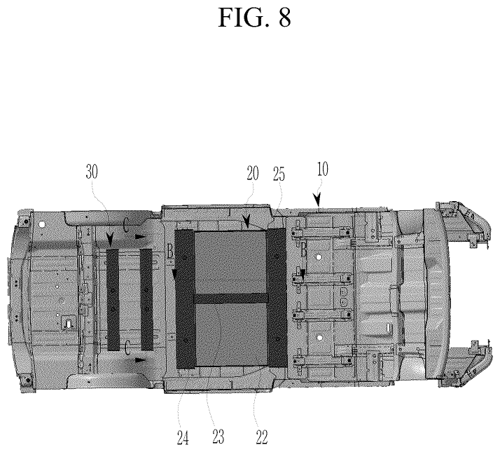

FIG. 8 is a diagram showing a center in-floor ramp module and a flattening rear member installed on a lower radial body member of a vehicle according to an embodiment of the disclosure.

Referring to FIG. 8, the ramp module 10 of a vehicle according to an embodiment of the disclosure may include a flattening rear member 30 installed to cover the rear portion member 8.

The flattening rear member 30 may include two members 30 formed side by side to extend in the transverse direction of the vehicle body 5 over the upper portion of the rear portion member 8 at the rear of the vehicle body 5.

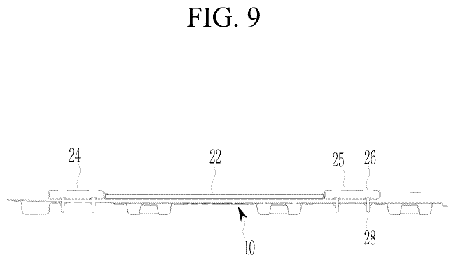

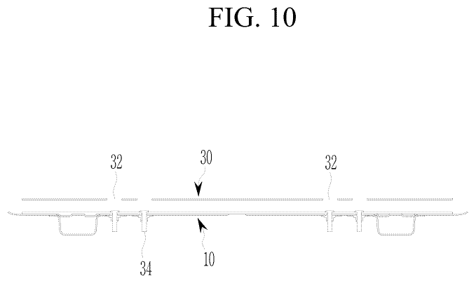

FIG. 9 is a cross-sectional view taken along line ‘B-B’ of FIG. 8, and FIG. 10 is a cross-sectional view taken along line ‘C-C’ of FIG. 8.

Referring to FIG. 9, a ramp 22 is disposed between the front ramp module member 25 and the rear ramp module member 24 of the center in-floor ramp module 20, and the front ramp module member 25 and the rear ramp module member 24 may be formed in the shape of a hollow bar extending in the transverse direction of the vehicle body 5.

The lower surfaces of the front ramp module member 25 and the rear ramp module member 24 may be fixed to the bottom surface of the vehicle body 5 by bolts 28. In addition, a tool entry hole 26 may be formed on an upper surface for coupling the bolt 28 to the vehicle body 5.

Referring to FIG. 10, the flattening rear member 30 may be formed in the shape of a hollow bar extending in the transverse direction of the vehicle body 5.

A lower surface of the flattening rear member 30 may be fixed to the bottom surface of the vehicle body 5 by bolts 34. In addition, a tool entry hole 32 may be formed on the upper surface for coupling the bolt 34 to the vehicle body 5.

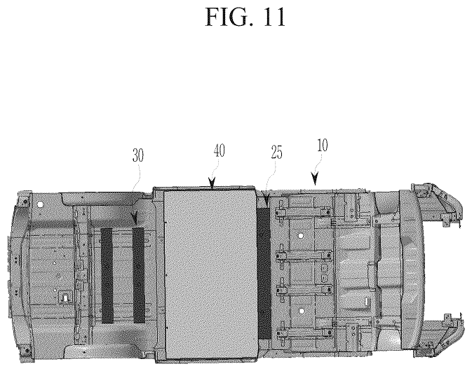

FIG. 11 is a view showing a center flattening panel installed on a ramp module member of a vehicle according to an embodiment of the disclosure.

Referring to FIG. 11, the ramp module 10 of a vehicle according to an embodiment of the disclosure includes a rear ramp module member 24, a center ramp module member 23, and a center flattening panel 40 covering the ramp 22. More may be included. The center flattening panel 40 may be mounted by being coupled to the rear ramp module member 24 and the center ramp module member 23 by bolts.

The center flattening panel 40 is a portion that an occupant directly touches and supports and may be formed of an aluminum (Al) sheet.

The ramp 22 is slidably disposed above the center flattening panel 40 in a height direction of the vehicle body, and with the ramp 22 drawn out to the outside of the center flattening panel 40, an upper surface of the ramp 22 and an upper surface of the center flattening panel 40 may be adjusted to match in height.

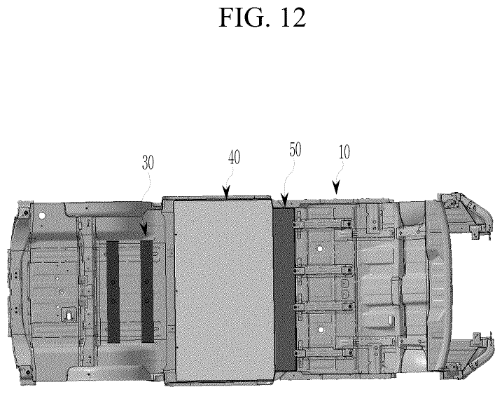

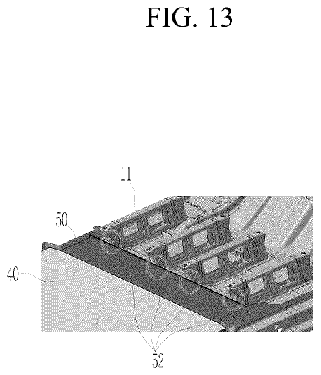

FIG. 12 is a diagram showing a center flattening panel and a front flattening panel installed on a ramp module member of a vehicle according to an embodiment of the disclosure, and FIG. 13 is an enlarged view showing a fixed state of a front flattening panel of FIG. 12.

Referring to FIG. 12, the ramp module 10 of a vehicle according to an embodiment of the disclosure may further include a front flattening panel 50 covering the front ramp module member 25.

The front flattening panel 50 may be coupled to the front ramp module member 25 by bolts so as to be mounted, and as shown in FIG. 13, the front flattening panel 50 may be fixed to the rear of a first-row seat member 11 of the vehicle body 5 by bolts 52.

The front flattening panel 50 may be formed of an aluminum (Al) sheet.

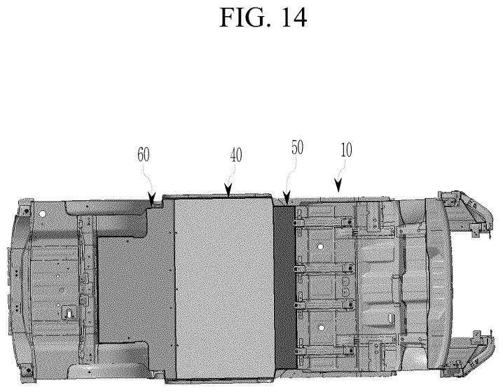

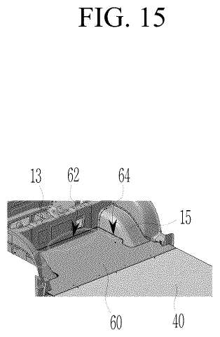

FIG. 14 is a diagram showing a center flattening panel, a front flattening panel, and a rear flattening panel installed on a ramp module member of a vehicle according to an embodiment of the disclosure, and FIG. 15 is an enlarged view showing a fixed state of a rear flattening panel of FIG. 14.

Referring to FIG. 14, the rear flattening panel 60 may be coupled to the flattening rear member 30 by bolts so as to be mounted, and as shown in FIG. 15, the rear flattening panel 60 may be fixed to the front of the third-row seat member 13 of the vehicle body 5 and a wheel side 15 by bolts 62 and 64.

The rear flattening panel 60 may be formed of an aluminum (Al) sheet.

In addition, the rear flattening panel 60 may be installed to have the same height as the center flattening panel 40.

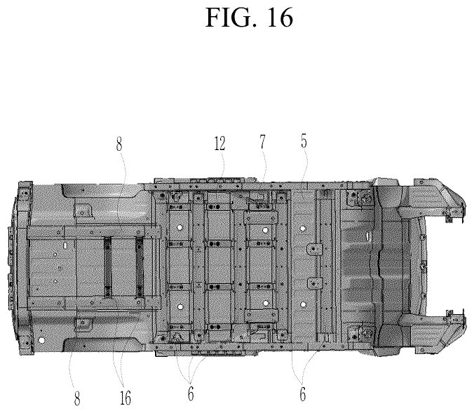

FIG. 16 is a diagram showing a rear portion reinforcing member further installed on a lower radial body member of a vehicle according to an embodiment of the disclosure.

As shown in FIG. 16, a rear portion reinforcing member 16 may be further connected and installed between the rear portion ramp module mounting members 14. The rear portion reinforcing member 16 may connect the longitudinally extending rear portion member 8 in the transverse direction to further reinforce the rigidity of the vehicle body 5, thereby further improving NVH and durability.

As such, according to an embodiment of the disclosure, by adopting a structure in which an in-floor ramp module for the transportation vulnerable is mounted on the lower radial body member, it may be commonly used as commonly as possible without changing existing vehicle models, thereby responding to a multi-specification PBV market.

In addition, by adding the ramp module mounting member to the lower radial body member, the rigidity of the vehicle body may be reinforced, thereby improving durability and crash performance.

In addition, by installing a flattening panel and employing a ramp device that is received above the flattening panel and slides through a side door of the vehicle, an attractive appearance may be achieved and loading and usability may be improved.

Although the embodiments of the disclosure have been described above, the disclosure is not limited to the above embodiments and includes any changes in the art recognized as being equivalent by a person skilled in the art to which the disclosure pertains from the embodiments of the disclosure.

What is claimed is:

1. A ramp module of a vehicle, the ramp module comprising:
a lower radial vehicle body member comprising:
a plurality of center portion members arranged in a center portion of a lower portion of a vehicle body of the vehicle in transverse and longitudinal directions of the vehicle body, respectively; and
a plurality of rear portion members arranged in the longitudinal direction of the vehicle body in a rear portion of the lower portion of the vehicle body;
a center portion ramp module mounting member connecting the center portion members arranged in the transverse direction;
a rear portion ramp module mounting member connecting the rear portion members and a bottom surface of the vehicle body;
a center in-floor ramp module covering the center portion member and configured to slide along the center portion members arranged in the transverse direction; and
a flattening rear member covering the rear portion members.

2. The ramp module of claim 1, wherein the center portion ramp module mounting member is connected to a side surface of the center portion members by welds.

3. The ramp module of claim 1, wherein the rear portion ramp module mounting member is connected to a side surface of the rear portion members by welds.

4. The ramp module of claim 1, wherein the center in-floor ramp module comprises:
a plurality of ramp module members fixed to the center portion members; and
a ramp slidable in the transverse direction of the vehicle body between the ramp module members.

5. The ramp module of claim 4, wherein the ramp module members comprise:
a front ramp module member and a rear ramp module member disposed in the transverse direction of the vehicle body; and
a center ramp module member connecting central portions of the front and rear ramp module members and disposed in the longitudinal direction of the vehicle body.

6. The ramp module of claim 5, wherein the front and rear ramp module members each have a shape of a hollow bar.

7. The ramp module of claim 6, wherein:
lower surfaces of the front and rear ramp module members are configured to be fixed to the vehicle body by bolts; and
tool entry holes are disposed on an upper surface for bolt connection.

8. The ramp module of claim 1, wherein the flattening rear member is disposed in the transverse direction of the vehicle body and has a shape of a hollow bar.

9. The ramp module of claim 8, wherein:
a lower surface of the flattening rear member is configured to be fixed to the vehicle body by a bolt; and
a tool entry hole is disposed on an upper surface for bolt connection.

10. The ramp module of claim 1, further comprising a rear portion reinforcing member disposed between the rear portion ramp module mounting member and a second rear portion ramp module mounting member.

11. A ramp module of a vehicle, the ramp module comprising:
a lower radial vehicle body member comprising:
a plurality of center portion members disposed in a center portion of a lower portion of a vehicle body of the vehicle in transverse and longitudinal directions of the vehicle body, respectively; and
a plurality of rear portion members disposed in the longitudinal direction of the vehicle body in a rear portion of the lower portion of the vehicle body;
a center portion ramp module mounting member connecting the center portion members disposed in the transverse direction;
a rear portion ramp module mounting member connecting the rear portion members and a bottom surface of the vehicle body;
a center in-floor ramp module covering the center portion member and configured to slide along the center portion members disposed in the transverse direction, the center in-floor ramp module comprising:
a front ramp module member and a rear ramp module member fixed to the center portion member and disposed in the transverse direction of the vehicle body;
a center ramp module member fixed to the center portion member, connecting central portions of the front and rear ramp module members, and disposed in the longitudinal direction of the vehicle body; and
a ramp slidable in the transverse direction of the vehicle body between the ramp module members;
a flattening rear member covering the rear portion member;
a center flattening panel covering the rear ramp module member, the center ramp module member, and the ramp;
a front flattening panel covering the front ramp module member; and
a rear flattening panel covering the flattening rear member.

12. The ramp module of claim 11, wherein the center flattening panel, the front flattening panel, and the rear flattening panel each comprise an aluminum sheet.

13. The ramp module of claim 11, wherein the front flattening panel is configured to be fixed to a rear surface of a first-row seat member of the vehicle body and the front ramp module member by a bolt.

14. The ramp module of claim 11, wherein the rear flattening panel is configured to be fixed to a front surface of a third-row seat member of the vehicle body, a wheel side, and the flattening rear member by a bolt.

15. A vehicle comprising:
a vehicle body comprising a first-row seat member and a third-row seat member;
a lower radial vehicle body member comprising:
a plurality of center portion members disposed in a center portion of a lower portion of the vehicle body in transverse and longitudinal directions of the vehicle body, respectively; and
a plurality of rear portion members disposed in the longitudinal direction of the vehicle body in a rear portion of the lower portion of the vehicle body;
a center portion ramp module mounting member connecting the center portion members disposed in the transverse direction;
a rear portion ramp module mounting member connecting the rear portion members and a bottom surface of the vehicle body;
a center in-floor ramp module covering the center portion member and configured to slide along the center portion members disposed in the transverse direction; and
a flattening rear member covering the rear portion members.

16. The vehicle of claim 15, wherein:
the center portion ramp module mounting member is connected to a side surface of the center portion members by first welds; and
the rear portion ramp module mounting member is connected to a side surface of the rear portion members by second welds.

17. The vehicle of claim 15, wherein the center in-floor ramp module comprises:
a plurality of ramp module members fixed to the center portion members; and
a ramp slidable in the transverse direction of the vehicle body between the ramp module members.

18. The vehicle of claim 17, wherein the ramp module members comprise:
a front ramp module member and a rear ramp module member disposed in the transverse direction of the vehicle body, the front and rear ramp module members each having a shape of a hollow bar, and lower surfaces of the front and rear ramp module members being fixed to the vehicle body by bolts accessible via tool entry holes; and
a center ramp module member connecting central portions of the front and rear ramp module members and disposed in the longitudinal direction of the vehicle body.

19. The vehicle of claim 15, wherein the flattening rear member is disposed in the transverse direction of the vehicle body and has a shape of a hollow bar.

20. The vehicle of claim 15, wherein:
the center in-floor ramp module comprises:
a front ramp module member and a rear ramp module member fixed to the center portion members and disposed in the transverse direction of the vehicle body;
a center ramp module member fixed to the center portion members, connecting central portions of the front and rear ramp module members, and disposed in the longitudinal direction of the vehicle body; and
a ramp slidable in the transverse direction of the vehicle body between the ramp module members; and
the vehicle further comprises:
a center flattening panel covering the rear ramp module member, the center ramp module member, and the ramp;
a front flattening panel covering the front ramp module member and fixed to a rear surface of the first-row seat member of the vehicle body and the front ramp module member; and
a rear flattening panel covering the flattening rear member and fixed to a front surface of the third-row seat member of the vehicle body, a wheel side, and the flattening rear member.
